(19) United States
(12) Patent Application Publication
(10) Pub. No.: US 2017/0343397 A1
(43) Pub. Date: Nov. 30, 2017

(54) ULTRASONIC METHOD AND DEVICE FOR MEASURING FLUID FLOW

(71) Applicant: General Electric Company, Schenectady, NY (US)

(72) Inventors: Jing YE, Shanghai (CN); Gregory Ronald GILETTE, Niskayuna, NY (US); Christopher Edward WOLFE, Niskayuna, NY (US); Xialei AO, Billerica, MA (US); Ran NUI, Shanghai (CN); Weihua SHANG, Shanghai (CN); Robert Arnold JUDGE, Houston, TX (US); Yan MEI, Shanghai (CN)

(73) Assignee: General Electric Company, Schenectady, NY (US)

(21) Appl. No.: 15/533,656

(22) PCT Filed: Dec. 2, 2015
(86) PCT No.: PCT/US2015/063402

§ 371 Date: Jun. 7, 2017

(30) Foreign Application Priority Data
Dec. 11, 2014 (CN) 201410766042.6

(51) Int. Cl. G01F 1/66; G01N 29/024; G01N 29/44; G01F 15/00

(52) U.S. Cl. CPC G01F 1/66; G01N 29/4472; G01N 29/024; G01F 15/00

(57) ABSTRACT

A method of measuring a flow rate of a fluid flowing in a space between an outer conduit and an inner element in the outer conduit is provided. Ultrasonic waves are transmitted and received through the space between multiple pairs of ultrasonic transducers along multiple propagation paths, respectively. A mean line velocity of the fluid is calculated based on data from each pair of ultrasonic transducers. As such, multiple mean line velocities across the space are obtained. The flow rate of the fluid is calculated based on the multiple mean line velocities.

### BACKGROUND

Ultrasonic devices and methods are widely used to measure the physical characteristics of a fluid, for example liquid and gas, flowing inside a pipe. There are various ultrasonic methods used to measure liquid flow rates, wherein one of the most widely used methods in current applications is the transit-time method.

As illustrated in FIG. 1, in a typical transit-time method for measuring a flow rate of a liquid stream, an upstream ultrasonic transducer and a downstream ultrasonic transducer are utilized. By alternately transmitting and receiving a burst of sound energy between the two transducers and measuring the transit time that it takes for sound to travel between the two transducers, a first transmit time T_{down} that the sound travels from the upstream transducer to the downstream transducer and a second transmit time Tᵤₚ that the sound travels from the downstream transducer to the upstream transducer can be measured. The flow velocity V averaged over the sound path can be calculated by the following equations:

$$V = \frac{P}{2 sin θ} ( \frac{1}{{T}_{down}} - \frac{1}{{T}_{up}} ) ,$$

where P is the acoustic path through fluid and θ is the path angle.

The flow rate is calculated as Q=K*A*V, where A is the inner cross-section area of the pipe and K is the instrument coefficient. Usually, K is determined through calibration.

Such a transit-time method is applicable for flow measurement in different situations. However, flow measurement in such as an annular space between inner and outer pipes is a problem because the ultrasonic wave propagated between upstream and downstream transducers may be blocked by the inner pipe and the flow profile of the space is not well developed. Therefore, it is desired to have an ultrasonic device and method for dealing with flow measurement in an annular space.

### BRIEF DESCRIPTION

In one aspect, the present disclosure relates to a method, in which a fluid is flowed in a space between an outer conduit and an inner element in the outer conduit, and a flow rate of the fluid flowing in the space is measured. Ultrasonic waves are transmitted and received through the space between multiple pairs of ultrasonic transducers along multiple propagation paths, respectively. A mean line velocity of the fluid is calculated based on data from each pair of ultrasonic transducers. As such, multiple mean line velocities across the space are obtained. The flow rate of the fluid is calculated based on the multiple mean line velocities.

In another aspect, the present disclosure relates to an ultrasonic device. The ultrasonic device includes an outer conduit and multiple pairs of ultrasonic transducers. The outer conduit is configured to receive an inner element. Each pair of the ultrasonic transducers is arranged to allow an ultrasonic wave to be propagated through a space defined between the outer conduit and the inner element along a propagation path. The ultrasonic device further includes a processor for calculating a mean line velocity of a fluid flowing in the space based on data from each pair of ultrasonic transducers to obtain multiple mean line velocities across the space, and calculating a flow rate of the fluid based on the multiple mean line velocities.

### BRIEF DESCRIPTION OF THE DRAWINGS

The above and other aspects, features, and advantages of the present disclosure will become more apparent in light of the subsequent detailed description when taken in conjunction with the accompanying drawing in which:

FIG. 1 is a diagram illustrating a typical transit-time ultrasonic measurement method.

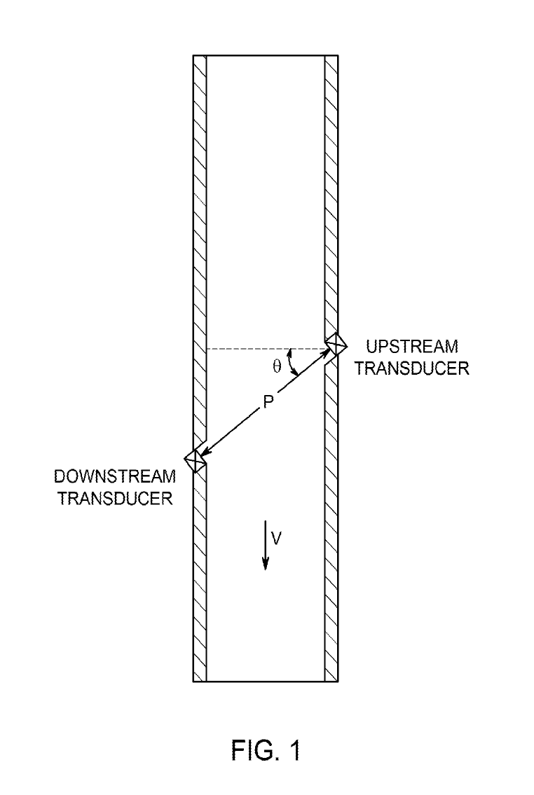

FIG. 2 is a schematic diagram illustrating an ultrasonic device according to one embodiment of the present disclosure.

FIG. 3 illustrates a vertical cross section of the ultrasonic device of FIG. 2 taken along a line A-A.

FIG. 4 is a schematic diagram illustrating propagation paths in an ultrasonic device according to one embodiment of the present disclosure.

FIG. 5 illustrates a top view of an ultrasonic device according to one embodiment of the present disclosure.

FIG. 6 illustrates a top view of an ultrasonic device according to another embodiment of the present disclosure.

### DETAILED DESCRIPTION

One or more specific embodiments of the present disclosure will be described below. Unless defined otherwise, technical and scientific terms used herein have the same meaning as is commonly understood by one of ordinary skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean either or all of the listed items. The use of “including,” “comprising” or “having” and variations thereof herein are meant to encompass the items listed thereafter and equivalents thereof as well as additional items. Moreover, the terms “coupled” and “connected” are not intended to distinguish between a direct or indirect coupling/connection between components. Rather, such components may be directly or indirectly coupled/connected unless otherwise indicated. The term “multiple” means two or more.

Embodiments of the present disclosure refer generally to an ultrasonic device applicable for measuring a flow rate of a fluid flowing in a space. The ultrasonic device includes an outer conduit configured to receive an inner element, and multiple pairs of ultrasonic transducers, each of which is arranged to allow an ultrasonic wave to be transmitted and received through a space defined between the outer conduit and the inner element along a propagation path The ultrasonic device may be coupled between upstream and downstream pipes like a joint, in a manner that a fluid is allowed to flow from the upstream pipe to the downstream pipe through the ultrasonic device.

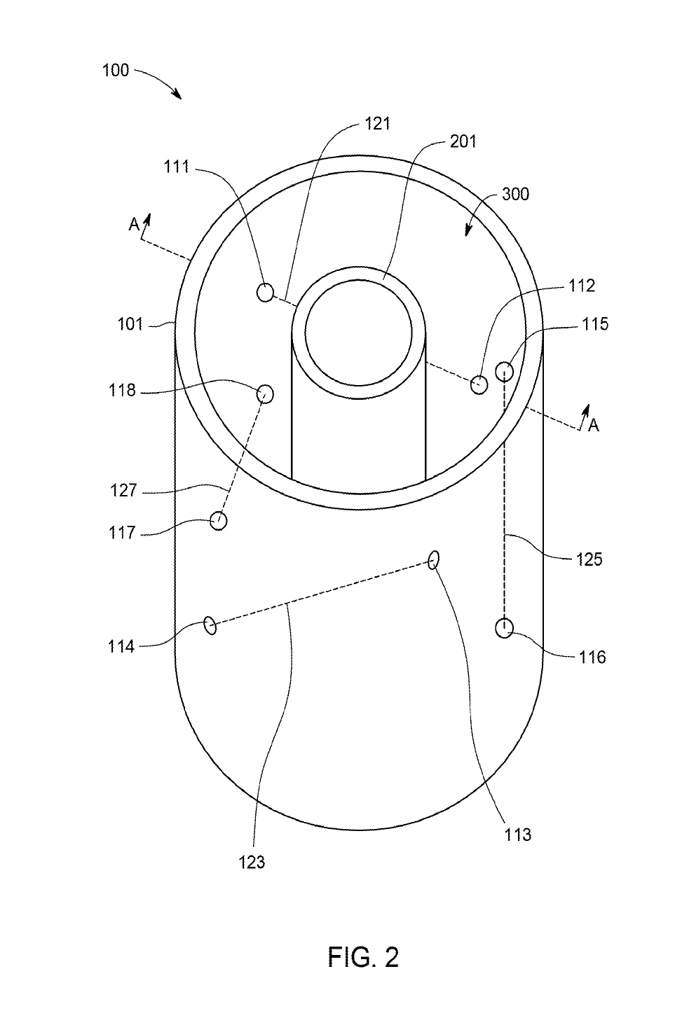

FIG. 2 is a schematic diagram illustrating an exemplary ultrasonic device 100. The ultrasonic device 100 includes an outer conduit 101 configured to receive an inner element such as an inner conduit 201. An annular space 300 is defined between the outer conduit 101 and the inner element 201 for a fluid to flow. The annular space 300 may be configured in different shapes depending on the shapes of the inner element and outer conduit. The ultrasonic device 100 further includes multiple pairs of ultrasonic transducers adapted to obtain data for calculating a flow rate of the fluid flowing in the annular space 300. In the illustrated embodiment, there are four pairs of ultrasonic transducers, a first pair of ultrasonic transducers 111 and 112, a second pair of ultrasonic transducers 113 and 114, a third pair of ultrasonic transducers 115 and 116, and a fourth pair of ultrasonic transducers 117 and 118. Each pair of ultrasonic transducers is arranged to allow an ultrasonic wave to be propagated within the annular space 300 between the pair of ultrasonic transducers along a propagation path without traversing the inner element 201.

As the four pairs of ultrasonic transducers are arranged in similar ways, the arrangement of the first pair of ultrasonic transducers 111 and 112 is described hereinafter in details as an example of the four pairs of ultrasonic transducers. As for the first pair of ultrasonic transducers 111 and 112, the ultrasonic transducer 111 is located in an upstream side of the ultrasonic transducer 112 along a flow direction of the fluid flowing in the annular space 300. In a specific embodiment, the ultrasonic transducers 111 and 112 are mounted on or within the outer conduit 101 and align with each other along a first chordal line 121 of the outer conduit 101, which is at an inclined angle to a cross-section of the outer conduit 101. As such, an ultrasonic wave can be propagated between the ultrasonic transducers 111 and 112 along the first chordal line 121 (the first propagation path). The first chordal line 121 traverses the annular space without traversing the inner element 201, which may be located at the center of the outer conduit 101. In a specific embodiment, the first chordal line 121 neither is parallel to nor intersects a central axis of the outer conduit 101, and thus is not coplanar with the central axis of the outer conduit 101.

Similarly, an ultrasonic wave may be propagated between the second pair of ultrasonic transducers 113 and 114 along a second chordal line 123 (a second propagation path), an ultrasonic wave may be propagated between the third pair of ultrasonic transducers 115 and 116 along a third chordal line 125 (a third propagation path), and an ultrasonic wave may be propagated between the fourth pair of ultrasonic transducers 117 and 118 along a fourth chordal line 127 (a fourth propagation path). In the illustrated embodiment, the second propagation path 123 is at an opposite side of the inner element 201 relative to the first propagation path 121. The third and fourth propagation paths 125 and 127 are at another two opposite sides of the inner element 201. The first, second, third and fourth propagation paths 121, 123, 125 and 127 substantially surround the inner element 201.

As the inner element 201 may waggle in the conduit 101, one or more of the propagation paths may be blocked during the flow measurement. By the arrangement as described above, it is ensured that at least one ultrasound propagation path is not blocked by the inner element 201 throughout the whole flow measurement even if the inner element 201 waggles in the conduit 101. In some embodiments, it is ensured that at most only one ultrasound propagation path is blocked by the inner element 201 throughout the whole flow measurement even if the inner element 201 waggles in the conduit 101. For example, in case the inner element 201 waggles to block the first propagation path 121, the second propagation path 123 at the opposite side of the first propagation path 121, the third propagation path 125 and the fourth propagation path 127 are not blocked by the inner element 201, because of the chordal design.

To ensure the ultrasonic waves propagated between the multiple pairs of ultrasonic transducers traverse a same measurement section of the annular space along the flow direction of the fluid, the multiple pairs of ultrasonic transducers may have their first ultrasonic transducers arranged at a same level relative to the flow direction, and have their second ultrasonic transducers arranged at another same level relative to the flow direction. For example, in the ultrasonic device 100 as illustrated in FIG. 2, the first ultrasonic transducers 111, 115, 113 and 117 of the four pairs are located substantially at a same plane perpendicular to the flow direction of the fluid flowing in the annular space 300, and the second ultrasonic transducers 112, 116, 114 and 118 of the four pairs are located substantially at another same plane perpendicular to the flow direction.

As for the pair of transducers arranged along a chordal line that does not intersect the central axis of the outer conduit 101, the ultrasound propagation path may be relatively shorter than that of a pair of transducers arranged along a line intersecting the central axis of the outer conduit 101. As such, the requirement of penetration depth for ultrasound is decreased, and thereby accuracy of flow measurement can be increased. In some embodiments, a distance between each pair of ultrasonic transducers may be optimized to increase accuracy of flow measurement and/or enable flow measurement of a highly attenuated fluid. For example, a distance between each pair of ultrasonic transducers may be designed to be short enough to enable flow measurement in the highly attenuated fluid, such as heavy mud. In some embodiments, the ultrasound propagation path between each pair of ultrasonic transducers along the chordal line is shorter than an inner diameter of the outer conduit 101, or even much shorter, for example, shorter than about 80 percent of the inner diameter of the outer conduit 101.

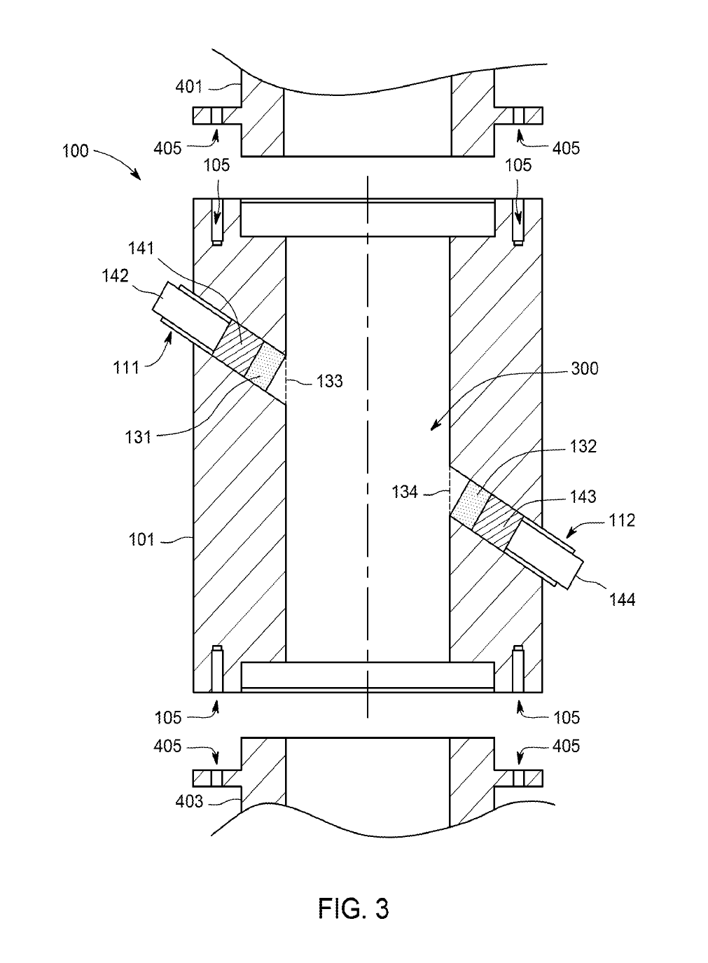

FIG. 3 illustrates a vertical cross section of the ultrasonic device 100 taken along a line A-A in FIG. 2. As illustrated in FIG. 3, the outer conduit 101 is configured to couple with one or more pipes 401 and 403. In a specific embodiment, there are bolt holes 105 defined in a side wall of the conduit 101 and corresponding bolt holes 405 defined in a flange of the pipe 401 or 403, and the conduit 101 is coupled to the pipes 401 and 403 via bolts (not shown) penetrating the bolt holes 105 and corresponding bolt holes 405. When the conduit 101 is coupled to the pipes 401 and 403, the conduit 101 is in fluid communication with the pipes 401 and 403 to form a connected pipe, which defines a continuous channel therein to receive an inner element as well as a fluid. In a specific embodiment, an inner element extends through the connected pipe, and a fluid is allowed to flow in an annular passage between the inner element and the connected pipe. In a specific embodiment, the inner element is an inner conduit defining a channel in fluid communication with the annular passage and is configured to feed a fluid into the annular passage, wherein the fluid in the channel of the inner conduit flows in a direction opposite to a flow direction of the fluid flowing in the annular passage.

The one or more pairs of ultrasonic transducers may be mounted on the conduit 101. In some embodiments, the ultrasonic transducers are installed on an outer surface of the conduit 101. In some embodiments, the ultrasonic transducers are installed in or through a wall of the conduit 101. As the fluid flowing in the conduit 101 may have a high temperature while the ultrasonic transducers may be sensitive to the temperature, a barrier such as a liner may be configured to thermally isolate the ultrasonic transducers mounted on the conduit 101 from the fluid in the conduit 101. As used herein, “to thermally isolate an ultrasonic transducer from a fluid” means to thermally isolate the entire ultrasonic transducer or at least a thermal sensitive part of the ultrasonic transducer from the fluid. The thermal sensitive part of the ultrasonic transducer may be a piezoelectric wafer or the like for constituting the ultrasonic transducer.

The barrier may have relatively higher thermal resistance and can effectively prevent the heat of the fluid from transferring to the ultrasonic transducers mounted on/in the conduit wall 104 behind the barrier. Moreover, the barrier may have relatively higher strength and can effectively withstand the pressure in the conduit 101. For example, both the thermal resistance and strength of the barrier may be higher than the conduit 101. In a specific embodiment, the barrier is made from a material including titanium. The barrier may be configured in various ways. For example, in some embodiments, the barrier may include a liner (inner layer) that covers an inner surface of the conduit 101. In some embodiments, the barrier may include head buffers (plugs) each installed ahead of one of the ultrasonic transducers to protect that ultrasonic transducer from the high temperature and/or high pressure of the fluid in the conduit 101.

In a specific embodiment as illustrated in FIG. 3, the ultrasonic transducer 111 includes a sensor 141 and a retainer 142 for retaining the sensor 141, and the ultrasonic transducer 112 includes a sensor 143 and a retainer 144 for retaining the sensor 143. Each of the sensors 141 and 143 has a thermal sensitive element such as a piezoelectric wafer (not shown) installed at a front end thereof. The ultrasonic transducers 111 and 112 are installed through a wall of the conduit 101. There are head buffers 131 and 132, installed ahead of the ultrasonic transducers 111 and 112 respectively, to physically and thermally isolate the ultrasonic transducers 111 and 112 from the fluid in the annular space 300.

Taking the head buffer 131 as an example, structures of the head buffers 131 and 132 will be described in detail hereinafter. The head buffer 131 provides a fluid facing surface facing and/or contacting the fluid flowing in the conduit 101, and a fitting surface substantially conforming to a front end of the ultrasonic transducer 111 where the thermal sensitive element is located. Air between the fitting surface of head buffer 131 and the front end of the ultrasonic transducer 111 can be dispelled by applying an acoustic couplant between the closely fitted surfaces. The fluid facing surface is substantially parallel to the front end of the sensor 141 to prevent the sound beam from refracting at the fluid facing surface. A recess may be formed by an inner surface of the conduit 101 and the fluid facing surface of the head buffer 131 that is parallel to the front end of the sensor 141. In order to prevent solid contained in the fluid from stocking in the recess to block the view of the sensor 141, in some embodiments, there may be a filter 133 in front of the fluid facing surface of the head buffer 131. The filter 133 may be a screen, which allows the liquid to pass and retains the solids contained in the liquid. In a specific embodiment, the filter 133 is flexible and deformable once it is bumped by the inner element received in the conduit 101, such that neither inner element is protected from being broken by the filter 133 nor the ultrasound propagation path is blocked by the solids in the flow during the flow measurement.

By such a head buffer 131, the thermal sensitive element at the front end of the ultrasonic transducer 111 is thermally isolated from both the fluid in the annular space 300 and the wall of the conduit 101 which may be in a relatively higher temperature due to the lower heat resistance compared with the head buffer 131. In some embodiments, there may be an additional flanged buffer (not shown) configured to isolate other parts of the ultrasonic transducer 111 from the conduit 101.

The head buffer 132 is configured in a similar way, and there is also a filter 134 in front of the fluid facing surface of the head buffer 132. The other ultrasonic transducers, such as ultrasonic transducers 113, 114, 115, 116, 117 and 118, may be installed in similar ways and have corresponding head buffers and/or flanged buffers thereof. The head buffers installed in front of the ultrasonic transducers can withstand high pressure and high temperature of the fluid flowing in the annular space. The flanged buffers can isolate the ultrasonic transducers from the conduit 101 to reduce short-circuit noise, which may occur in the conduit 101.

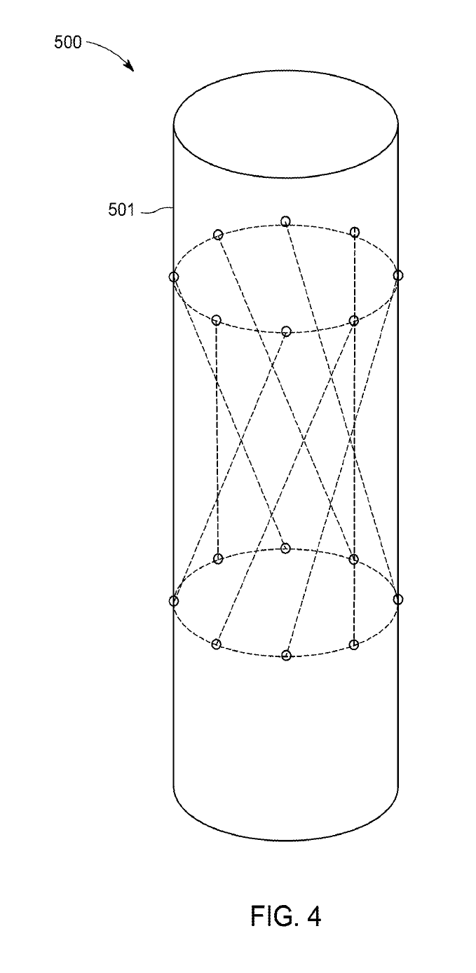

There is no limitation to either the number of pairs of ultrasonic transducers or the arrangements of these pairs of ultrasonic transducers. There may be only one pair, two or three pairs, or more than four pairs of ultrasonic transducers in different embodiments. In some embodiments, two or more sets of the four pairs of ultrasonic transducers as described above may be used. The ultrasonic transducers may be arranged in different ways as long as it is ensured that at least one ultrasound propagation path is not blocked by the inner element during the flow measurement. For example, in an ultrasonic device 500 as illustrated in FIG. 4, there are two sets of four pairs, i.e., eight pairs of ultrasonic transducers arranged on an outer conduit 501 to form eight ultrasound propagation paths indicated in FIG. 4 by dotted lines.

Through the multiple pairs of ultrasonic transducers as described above, the flow rate of a fluid flowing in an annular space between an outer conduit and an inner element can be measured. During the measurement, a fluid is flowed in the space, and ultrasonic waves are transmitted and received through the space between the multiple pairs of ultrasonic transducers along the multiple propagation paths, respectively. Each pair of ultrasonic transducers may work in a transmit-receive mode or a pulse-echo mode. In some embodiments, each pair of ultrasonic transducers works in a conventional transit-time pattern, in which the upstream transducer transmits ultrasonic signals whereas the downstream transducer receives the ultrasonic signals for one or more times, and then the downstream transducer transmits ultrasonic signals whereas the upstream transducer receives the ultrasonic signals for one or more times. In some embodiments, both the upstream and downstream transducers in the pair work simultaneously to decrease the response time of the transducers.

Data for calculating a mean line velocity of the fluid can be obtained from each pair of ultrasonic transducers. The data includes a difference in propagation time of the ultrasonic wave in opposite directions between said pair of ultrasonic transducers. Through one or more processor such as computers or other processing devices, multiple mean line velocities across the annular space can be obtained based on data from the multiple pairs of ultrasonic transducers, and the flow rate such as volumetric flow rate of the fluid can be calculated based on the multiple mean line velocities.

In some embodiments, the flow rate (FR) is calculated by:

$$FR = \frac{{\sum }_{i = 1}^{n} {FR}_{i}}{n} ,$$

wherein i is the i^{th} direction of the propagation paths, n is the total number of the directions, FRᵢ=Σⱼ₌₁^{m}v̅_̅{̅i̅,̅j̅}̅·s_{i,j}.

wherein j is the i^{th} propagation path in the i^{th} direction, m is the total number of the propagation paths in the i^{th} direction, v̅_̅{̅i̅,̅j̅}̅ is the mean line velocity of the fluid along the j^{th} propagation path in the i^{th} direction, s_{i,j} is an area relative to the j^{th} propagation path in the i^{th} direction. Specifically, s_{i,j} is an area covering or corresponding to the j^{th} propagation path in the direction and may vary depending on the total number of the propagation paths as well as the shape and size of the space, wherein Σᵢ₌₁ⁿ Σⱼ₌₁^{m}s_{i,j} is a sectional area of the space.

The use of multiple pairs of ultrasonic transducers enables multiple measurements to increase the accuracy because the measurement by multiple pairs of ultrasonic transducers covers more area of the fluid in the annular space, which makes the measurement more reliable. There is no limitation to either the number of the directions or the number of the propagation paths in each of the directions. In order to cover as much area in the annular space as possible by less pairs of ultrasonic transducers, the multiple propagation paths may extend along at least one set of two directions that are substantially perpendicular to each other. In some embodiments, in at least one of the directions, there are at least two propagation paths at two opposite sides of the inner element. Particularly, in some specific embodiments, there are at least two propagation paths at two opposite sides of the inner element in each of the directions.

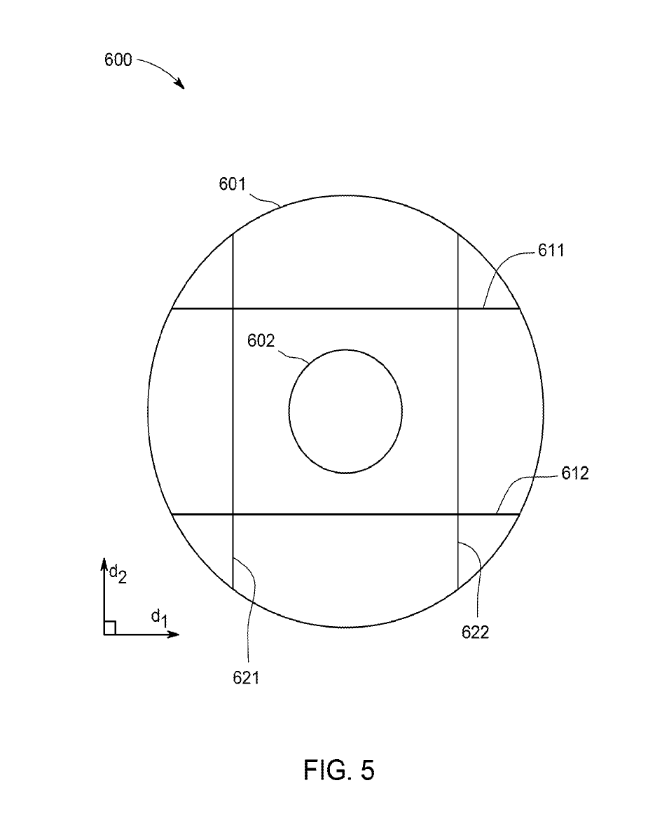

For example, as illustrated in FIG. 5, which shows a top view of an ultrasonic device 600 having an outer conduit 601 configured to couple with one or more pipes and receive an inner element 602. Four pairs of ultrasonic transducers (not shown) generate four propagation paths 611, 612, 621 and 622 extending along chordal lines of the outer conduit 601 without traversing the inner element 602. The propagation paths 611 and 612 extend along a first direction d₁ at two opposite sides of the inner element 602, respectively, whereas the propagation paths 621 and 622 extend along a second direction d₂ substantially perpendicular to the first direction d₁ at two opposite sides of the inner element 602, respectively. The four propagation paths 611, 612, 621 and 622 substantially surround the inner element 602.

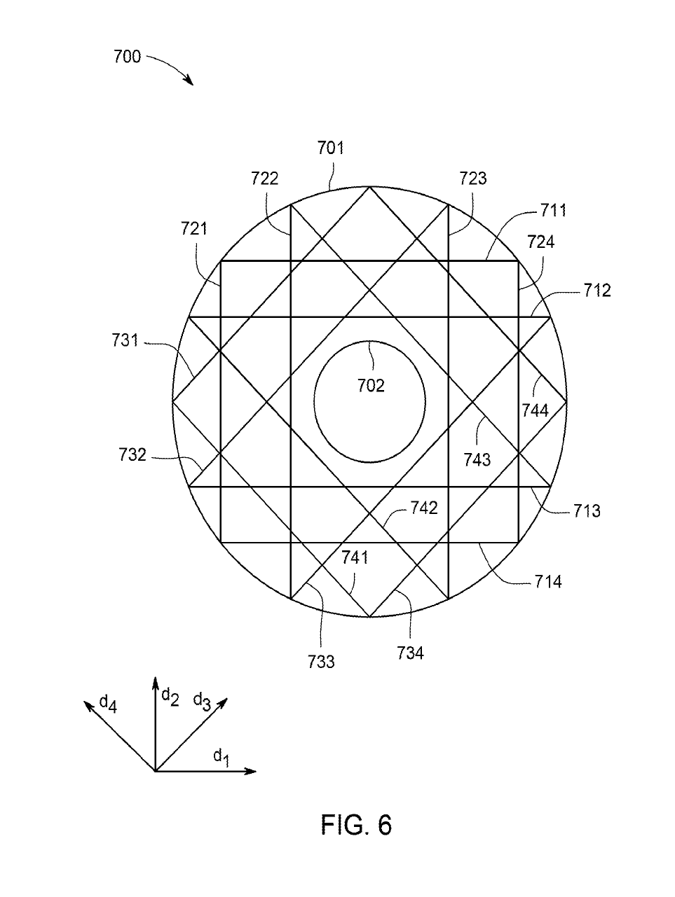

As illustrated in FIG. 6, which shows a top view of an ultrasonic device 700 having an outer conduit 701 configured to couple with one or more pipes and receive an inner element 702. Sixteen pairs of ultrasonic transducers (not shown) generate sixteen propagation paths 711, 712, 713, 714 721, 722, 723, 724, 731, 732, 733, 734, 741, 742, 743 and 744 extending along chordal lines of the outer conduit 701. As to the directions of these propagation paths, there are two more directions d₃ and d₄ in addition to the first direction d₁ and second direction d₂ as illustrated in FIG. 5. The directions d₃ and d₄ are substantially perpendicular to each other and each of the directions d₃ and d₄ is at substantially the same angle to the directions d₁ and d₂. Propagation paths 711, 712, 713 and 714 extend along the first direction d₁, wherein the propagation paths 711 and 712 are at one side of the inner element 702 and the propagation paths 713 and 714 are at the opposite side of the inner element 702. Propagation paths 721, 722, 723 and 724 extend along the first direction d₂, wherein the propagation paths 721 and 722 are at one side of the inner element 702 and the propagation paths 723 and 724 are at the opposite side of the inner element 702. Propagation paths 731, 732, 733 and 734 extend along the first direction d₃, wherein the propagation paths 731 and 732 are at one side of the inner element 702 and the propagation paths 733 and 734 are at the opposite side of the inner element 702. Propagation paths 741, 742, 743 and 744 extend along the first direction d₄, wherein the propagation paths 741 and 742 are at one side of the inner element 702 and the propagation paths 743 and 744 are at the opposite side of the inner element 702.

In the embodiments as described above, the locations of at least one pair of ultrasonic transducers are designed to make its ultrasound propagation path extend along a chordal line of the outer conduit that does not traverse the inner element. In such a chordal arrangement, the ultrasound propagation path of at least one pair of ultrasonic transducers is not be blocked by the inner element, which enables flow measurement in an annular space. Moreover, such an arrangement enables a relatively shorter ultrasound propagation path, and thus the requirement of penetration depth for ultrasound is decreased to enable flow measurement of larger scale of flow in higher attenuated fluid. Further, by optimizing the arrangement of the ultrasound propagation paths across the annular space and calculating the flow rate by the algorithm as described above, the ultrasonic devices are capable of providing flow measurement of high accuracy.

The invention may be embodied in other specific forms without departing from the spirit or essential characteristics thereof. The foregoing embodiments are therefore to be considered in all respects as illustrative rather than limiting on the invention described herein. The scope of embodiments of the invention is thus indicated by the appended claims rather than by the foregoing description, and all changes that come within the meaning and range of equivalency of the claims are therefore intended to be embraced therein.

1. A method, comprising:
flowing a fluid in a space between an outer conduit and an inner element in the outer conduit;
transmitting and receiving ultrasonic waves through the space between multiple pairs of ultrasonic transducers along multiple propagation paths, respectively;
calculating a mean line velocity of the fluid based on data from each pair of ultrasonic transducers, to obtain multiple mean line velocities across the space; and
calculating a flow rate of the fluid based on the multiple mean line velocities.

2. The method according to claim 1, wherein at least one of the ultrasonic waves is transmited and received through the space without traversing the inner element.

3. The method according to claim 1, wherein the flow rate (FR) is calculated by
$$FR = \frac{{\sum }_{i = 1}^{n} {FR}_{i}}{n} ,$$
wherein i is the i^{th} direction of the propagation paths, n is the total number of the directions, FRᵢ=Σⱼ₌₁^{m}v̅_̅{̅i̅,̅j̅}̅·s_{i,j}, wherein j is the j^{th} propagation path in the i^{th} direction, in is the total number of the propagation paths in the i^{th} direction, v̅_̅{̅i̅,̅j̅}̅ is the mean line velocity of the fluid along the j^{th} propagation path in the i^{th} direction, s_{i,j} is an area related with the j^{th} propagation path in the i^{th} direction.

4. The method according to claim 3, wherein the propagation paths in at least one of the directions comprise two propagation paths at two opposite sides of the inner element.

5. The method according to claim 3, wherein the propagation paths in each of the directions comprise two propagation paths at two opposite sides of the inner element.

6. The method according to claim 3, wherein the directions comprise a set of two directions d₁ and d₂ substantially perpendicular to each other.

7. The method according to claim 6, wherein the propagation paths in the direction d₁ comprise first and second propagation paths at two opposite sides of the inner element, and the propagation paths in the direction d₂ comprise third and fourth propagation paths at two opposite sides of the inner element, the first, second, third and fourth propagation paths substantially surrounding the inner element.

8. The method according to claim 6, wherein the directions further comprise a set of two directions d₃ and d₄ substantially perpendicular to each other, wherein at least one of the directions d₃ and d₄ is at substantially the same angle to the directions d₁ and d₂.

9. The method according to claim 8, wherein the propagation paths in the direction d₃ comprise fifth and sixth propagation paths at two opposite sides of the inner element, and the propagation paths in the direction d₄ comprise seventh and eighth propagation paths at two opposite sides of the inner element, the fifth, sixth, seventh and eighth propagation paths substantially surrounding the inner element.

10. The method according to claim 1, wherein data from each pair of ultrasonic transducers comprises a difference in propagation time of the ultrasonic wave in opposite directions between said pair of ultrasonic transducers.

11. The method according to claim 1, wherein the multiple pairs of ultrasonic transducers each comprises a first ultrasonic transducer and a second ultrasonic transducer wherein the first ultrasonic transducer is located in an upstream side of the second ultrasonic transducer along a flow direction of the fluid flowing in the space.

12. An ultrasonic device, comprising:
an outer conduit configured to receive an inner element;
multiple pairs of ultrasonic transducers, each pair arranged to allow an ultrasonic wave to be propagated through a space defined between the outer conduit and the inner element along a propagation path; and
a processor for calculating a mean line velocity of a fluid flowing in the space based on data from each pair of ultrasonic transducers to obtain multiple mean line velocities across the space, and calculating a flow rate of the fluid based on the multiple mean line velocities.

13. The ultrasonic device according to claim 12, wherein the processor is configured to calculate the flow rate (FR) by
$$FR = \frac{{\sum }_{i = 1}^{n} {FR}_{i}}{n} ,$$
wherein i is the i^{th} direction of the propagation paths, n is the total number of the directions, FRᵢ=Σⱼ₌₁^{m}v̅_̅{̅i̅,̅j̅}̅·s_{i,j}, wherein j is the j^{th} propagation path in the i^{th} direction, m is the total number of the propagation paths in the i^{th} direction, v̅_̅{̅i̅,̅j̅}̅ is the mean line velocity of the fluid along the j^{th} propagation path in the i^{th} direction, s_{i,j} is an area related with the j^{th} propagation path in the i^{th} direction.

14. The ultrasonic device according to claim 13, wherein the propagation paths in at least one of the directions comprise two propagation paths at two opposite sides of the inner element.

15. The ultrasonic device according to claim 13, wherein the directions comprise a set of two directions d₁ and d₂ substantially perpendicular to each other.

16. The ultrasonic device according to claim 15, wherein the propagation paths in the direction dⱼ comprise first and second propagation paths at two opposite sides of the inner element, and the propagation paths in the direction d₂ comprise third and fourth propagation paths at two opposite sides of the inner element, the first, second, third and fourth propagation paths substantially surrounding the inner element.

17. The ultrasonic device according to claim 15, wherein the directions further comprise a set of two directions d₃ and d₄ substantially perpendicular to each other, wherein st least one of the directions d₃ and d₄ is at substantially the same angle to the directions d₁ and d₂.

18. The ultrasonic device according to claim 17, wherein the propagation paths in the direction d₃ comprise fifth and sixth propagation paths at two opposite sides of the inner element, and the propagation paths in the direction d₄ comprise seventh and eighth propagation paths at two opposite sides of the inner element, the fifth, sixth, seventh and eighth propagation paths substantially surrounding the inner element.

19. The ultrasonic device according to claim 12, wherein the multiple pairs of ultrasonic transducers each comprises a first ultrasonic transducer and a second ultrasonic transducer wherein the first ultrasonic transducer is located in an upstream side of the second ultrasonic transducer along a flow direction of the fluid flowing in the space.

20. The ultrasonic device according to claim 12, wherein the multiple pairs of ultrasonic transducers are arranged to ensure that the ultrasonic wave between at least one pair of ultrasonic transducers is propagated through the space without traversing the inner element.
